(19) United States
(12) Patent Application Publication
(10) Pub. No.: US 2026/0148567 A1
(43) Pub. Date: May 28, 2026

(54) SURROUNDING ENVIRONMENT DETERMINATION DEVICE

(71) Applicant: TOYOTA JIDOSHA KABUSHIKI KAISHA, Toyota-shi (JP)

(72) Inventor: Takuya NOMURA, Chita-gun (JP)

(73) Assignee: TOYOTA JIDOSHA KABUSHIKI KAISHA, Toyota-shi (JP)

(21) Appl. No.: 19/390,901

(22) Filed: Nov. 17, 2025

(30) Foreign Application Priority Data
Nov. 27, 2024 (JP) 2024-206654

(51) Int. Cl. G06V 20/58

(52) U.S. Cl. CPC G06V 20/58; G06V 2201/08

(57) ABSTRACT

A surrounding environment determination device includes a camera and a surrounding environment detection unit configured to detect an environment condition around an own vehicle, the camera, a target detection unit and an other vehicle determination unit configured to detect whether another vehicle that passes through the own vehicle or another oncoming vehicle that goes by the own vehicle exists, and an adverse environment determination unit configured to determine whether a surrounding environment of the own vehicle is an adverse environment and whether the other vehicle exists. The adverse environment determination unit is configured to perform a comparison a detection score of the environment condition around the own vehicle with an adverse environment threshold according to the environment condition around the own vehicle, and determine whether the surrounding environment of the own vehicle is an adverse environment.

### CROSS-REFERENCE TO RELATED APPLICATION

This application claims priority to Japanese Patent Application No. 2024-206654 filed on November 27, 2024. The disclosure of the above-identified application, including the specification, drawings, and claims, is incorporated by reference herein in its entirety.

### BACKGROUND

### TECHNICAL FIELD

The present disclosure relates to a surrounding environment determination device.

### DESCRIPTION OF RELATED ART

As a surrounding environment determination device, for example, a technique described in Japanese Unexamined Patent Application Publication No. 2022-14729 (JP 2022-14729 A) is known. The surrounding environment determination device described in JP 2022-14729 A acquires recognition information of a target planimetric feature including a landmark by analyzing an image captured by an imaging device that captures an image of a predetermined range around a vehicle, and determines whether a surrounding environment of the vehicle is an adverse environment for object recognition using the image, based on the recognition information of the target planimetric feature. When a target planimetric feature is not recognized within a predetermined distance from the imaging device, it is determined that the surrounding environment of the vehicle is an adverse environment.

### SUMMARY

However, in the above-described technique, whether the surrounding environment of the vehicle is an adverse environment is determined based on a detection state of the landmark (stationary object), and thus, there is a possibility that responsiveness until it is determined that the surrounding environment is an adverse environment may be slow depending on conditions. Specifically, it is determined that the surrounding environment is an adverse environment as a result of visibility of the landmark being lowered at a time point at which visibility in front of the own vehicle becomes poor due to a spray of rain or snow splashed by another vehicle (passing vehicle) that tries to pass through the own vehicle or another oncoming vehicle (oncoming vehicle) that goes by the own vehicle. Further, during night-time, and the like, performance of detecting the landmark itself is likely to be lowered, and thus, there is a possibility that responsiveness until it is determined that the surrounding environment is an adverse environment may become further slow or it may be difficult to determine whether the surrounding environment is an adverse environment.

The present disclosure provides a surrounding environment determination device capable of determining whether a surrounding environment of an own vehicle is an adverse environment with high accuracy and quickly even when there is a passing vehicle or an oncoming vehicle.

### Aspect 1

One aspect of the present disclosure is a surrounding environment determination device configured to determine a surrounding environment of an own vehicle upon control of high beam of the own vehicle. The surrounding environment determination device includes a surrounding condition detection unit configured to detect an environment condition around the own vehicle, an other vehicle detection unit configured to detect whether another vehicle that passes through the own vehicle or another oncoming vehicle that goes by the own vehicle exists, and an adverse environment determination unit configured to determine whether the surrounding environment of the own vehicle is an adverse environment based on the environment condition around the own vehicle detected by the surrounding condition detection unit and whether the other vehicle exists detected by the other vehicle detection unit. The adverse environment determination unit is configured to perform a comparison a detection score of the environment condition around the own vehicle with an adverse environment threshold according to the environment condition around the own vehicle, and determine whether the surrounding environment of the own vehicle is an adverse environment based on a result of the comparison. The adverse environment threshold differs depending on whether the other vehicle exists.

### Aspect 2

In aspect 1 described above, the surrounding condition detection unit may be configured to detect a state of rain or snow as the environment condition. The adverse environment threshold may differ depending on whether the other vehicle exists and the state of rain or snow.

### Aspect 3

In aspect 2 described above, the adverse environment threshold when the other vehicle exists may be smaller than the adverse environment threshold when the other vehicle does not exist. The adverse environment threshold for the state of snow may be smaller than the adverse environment threshold for the state of rain.

### Aspect 4

In one of aspect 1 to aspect 3 described above, the other vehicle detection unit may be configured to detect whether the other vehicle exists within a specified distance from the own vehicle. The adverse environment determination unit may be configured to change the adverse environment threshold depending on the environment condition around the own vehicle when the other vehicle detection unit detects that the other vehicle exists within the specified distance from the own vehicle.

### Aspect 5

In one of aspect 1 to aspect 4 described above, the surrounding condition detection unit may be configured to detect the environment condition around the own vehicle using a camera that is configured to capture an image of a circumference of the own vehicle. The other vehicle detection unit may be configured to detect whether the other vehicle exists using the camera.

According to the present disclosure, even when a passing vehicle or an oncoming vehicle exists, it is possible to determine whether the surrounding environment of the own vehicle is an adverse environment with high accuracy and quickly.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram illustrating a vehicle headlight control device including a surrounding environment determination device according to an embodiment of the present disclosure;

FIG. 2 is a flowchart indicating a procedure of determination/control processing to be executed by an ECU illustrated in FIG. 1;

FIG. 3A is a view illustrating an example of image data of a camera when a passing vehicle passes through an own vehicle;

FIG. 3B is a view illustrating an example of the image data of the camera when the passing vehicle passes through the own vehicle;

FIG. 3C is a view illustrating an example of the image data of the camera when the passing vehicle passes through the own vehicle;

FIG. 3D is a view illustrating an example of the image data of the camera when the passing vehicle passes through the own vehicle;

FIG. 3E is a view illustrating an example of the image data of the camera when the passing vehicle passes through the own vehicle;

FIG. 4A is a graph indicating a condition score of snow and an adverse environment threshold when the passing vehicle passes through the own vehicle;

FIG. 4B is a graph indicating the condition score of snow and the adverse environment threshold when the passing vehicle passes through the own vehicle;

FIG. 4C is a graph indicating the condition score of snow and the adverse environment threshold when the passing vehicle passes through the own vehicle;

FIG. 4D is a graph indicating the condition score of snow and the adverse environment threshold when the passing vehicle passes through the own vehicle; and

FIG. 4E is a graph indicating the condition score of snow and the adverse environment threshold when the passing vehicle passes through the own vehicle.

### DETAILED DESCRIPTION OF EMBODIMENTS

An embodiment of the present disclosure will be described in detail below with reference to the drawings.

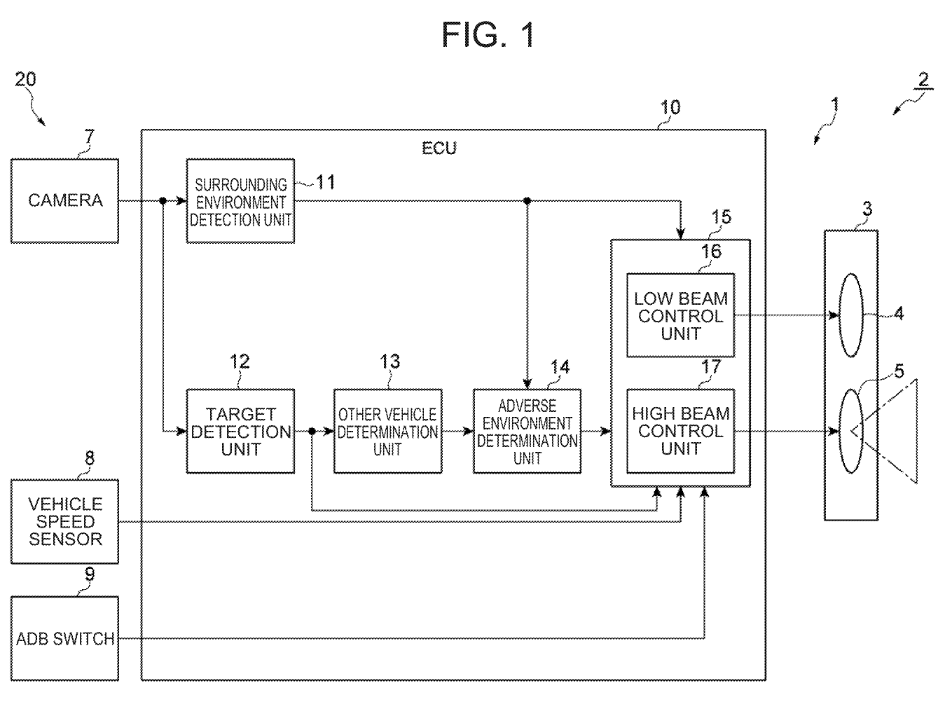

FIG. 1 is a schematic configuration diagram illustrating a vehicle headlight control device including a surrounding environment determination device according to an embodiment of the present disclosure. In FIG. 1, a vehicle headlight control device 1 is mounted on an own vehicle 2 including an adaptive driving beam (ADB) function of automatically switching beam between high beam and low beam. The present disclosure is applicable to autonomous driving. The vehicle 2 may be an autonomous vehicle.

The vehicle headlight control device 1 is a device that controls two head lamps 3 (head lamps) respectively arranged on both the right side and the left side at a front portion of the own vehicle 2. The vehicle headlight control device 1 detects a road condition in front of the own vehicle 2 and a surrounding environment and controls the head lamp 3 to switch beam from high beam to low beam at an appropriate timing. The head lamp 3 includes a low beam light source 4 and a high beam light source 5.

The vehicle headlight control device 1 include a camera 7, a vehicle speed sensor 8, an ADB switch 9, and an electronic control unit (ECU) 10.

The camera 7 is an imaging unit that captures an image of a circumference of the own vehicle 2 to acquire image data of the circumference of the own vehicle 2. The circumference of the own vehicle 2 includes portions in front of, behind, and lateral to the own vehicle 2. As the camera 7, for example, a monocular camera, a stereo camera, or the like, is used.

The vehicle speed sensor 8 is a sensor that detects a traveling speed (vehicle speed) of the own vehicle 2. The ADB switch 9 is a manual switch for a driver of the own vehicle 2 to enable (turn ON) or disable (turn OFF) the adaptive driving beam function.

The ECU 10 includes a CPU, a RAM, a ROM, an input/output interface, and the like. The ECU 10, for example, loads a program recorded in the ROM to the RAM and executes the program loaded to the RAM by the CPU.

The ECU 10 includes a surrounding environment detection unit 11, a target detection unit 12, an other vehicle determination unit 13, an adverse environment determination unit 14, and a lamp control unit 15.

The camera 7, the surrounding environment detection unit 11, the target detection unit 12, the other vehicle determination unit 13, and the adverse environment determination unit 14 constitute a surrounding environment determination device 20 of the present embodiment. The surrounding environment determination device 20 is a device that determines an environment around the own vehicle 2 upon control of high beam of the own vehicle 2.

The surrounding environment detection unit 11 detects an environment condition around the own vehicle 2 based on the image data acquired by the camera 7. The surrounding environment detection unit 11 constitutes a surrounding condition detection unit that detects an environment condition around the own vehicle 2 in cooperation with the camera 7. In other words, the surrounding condition detection unit detects the environment condition around the own vehicle 2 using the camera 7. The surrounding environment detection unit 11 detects a state of rain or snow around the own vehicle 2 as the environment condition around the own vehicle 2. Note that sleet, hail, and hailstone are included in rain.

The target detection unit 12 detects a target existing around the own vehicle 2 based on the image data acquired by the camera 7. The target includes another vehicle, a two-wheel vehicle, a person, an obstacle, and the like.

The other vehicle determination unit 13 determines whether another vehicle (passing vehicle) that passes through the own vehicle 2 or another oncoming vehicle (oncoming vehicle) that goes by the own vehicle 2 exists based on the detection result of the target detection unit 12. The other vehicle determination unit 13 determines whether the passing vehicle or the oncoming vehicle exists within a specified distance from the own vehicle 2.

The target detection unit 12 and the other vehicle determination unit 13 constitute an other vehicle detection unit that detects whether another vehicle that passes through the own vehicle 2 or another oncoming vehicle that goes by the own vehicle exists in cooperation with the camera 7.

The adverse environment determination unit 14 determines whether the surrounding environment of the own vehicle 2 is an adverse environment based on the environment condition around the own vehicle 2 detected by the surrounding environment detection unit 11 and whether a passing vehicle or an oncoming vehicle exists determined by the other vehicle determination unit 13.

The adverse environment determination unit 14 determines whether the surrounding environment of the own vehicle 2 is an adverse environment by comparing a detection score of the environment condition around the own vehicle 2 with an adverse environment threshold according to the environment condition around the own vehicle 2.

The adverse environment threshold differs depending on whether a passing vehicle or an oncoming vehicle exists and a state of rain or snow. The adverse environment threshold when a passing vehicle or an oncoming vehicle exists is smaller than the adverse environment threshold when neither a passing vehicle nor an oncoming vehicle exists. The adverse environment threshold for a state of snow is smaller than the adverse environment threshold for a state of rain. Note that the adverse environment threshold will be described in detail later.

The adverse environment determination unit 14 changes the adverse environment threshold depending on the environment condition around the own vehicle 2 when the other vehicle determination unit 13 determines that a passing vehicle or an oncoming vehicle exists within a specified distance from the own vehicle 2.

When the adaptive driving beam function is enabled (turned ON) by the ADB switch 9, the lamp control unit 15 controls the low beam light source 4 and the high beam light source 5 of the head lamp 3 so as to switch beam between high beam and low beam based on the environment condition around the own vehicle 2 detected by the surrounding environment detection unit 11, the detection result of the target detection unit 12, the determination result of the other vehicle determination unit 13, and the vehicle speed of the own vehicle 2 detected by the vehicle speed sensor 8. The lamp control unit 15 includes a low beam control unit 16 that controls the low beam light source 4, and a high beam control unit 17 that controls the high beam light source 5.

The high beam control unit 17 controls the high beam light source 5 to radiate high beam upon satisfaction of a condition that neither an oncoming vehicle nor a preceding vehicle is traveling in front of the own vehicle 2, a condition that there is no light source such as a street lamp, and the circumference of the own vehicle 2 is darker than necessary, and a condition that the own vehicle 2 is traveling at a speed equal to or higher than a specified speed. The high beam control unit 17 controls the high beam light source 5 to stop radiation of high beam when one of the above-described three conditions is not satisfied.

The low beam control unit 16 controls the low beam light source 4 to stop radiation of low beam upon satisfaction of a condition that neither an oncoming vehicle nor a preceding vehicle is traveling in front of the own vehicle 2, a condition that there is no light source such as a street lamp, and the circumference of the own vehicle 2 is darker than necessary, and a condition that the own vehicle 2 is traveling at a speed equal to or higher than the specified speed. The low beam control unit 16 controls the low beam light source 4 to radiate low beam when one of the above-described three conditions is not satisfied.

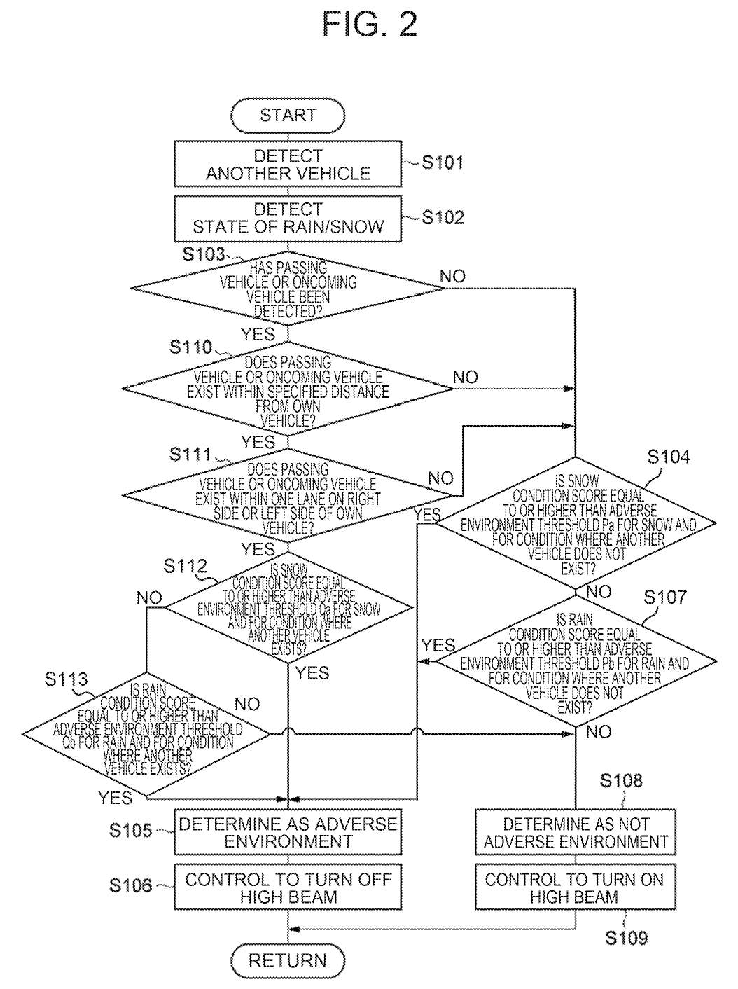

FIG. 2 is a flowchart indicating a procedure of determination/control processing to be executed by the ECU 10. The processing indicated in FIG. 2 is processing of determining the surrounding environment of the own vehicle 2 and controlling the high beam light source 5 depending on the determination result.

In FIG. 2, the ECU 10 first detects whether another vehicle exists based on the image data of the camera 7 (procedure S101). Further, the ECU 10 detects a state of rain or snow based on the image data of the camera 7 (procedure S102). Subsequently, the ECU 10 determines whether a passing vehicle or an oncoming vehicle has been detected as the other vehicle detected in procedure S101 (procedure S103).

When it is determined that neither a passing vehicle nor an oncoming vehicle is detected, the ECU 10 determines whether a condition score of snow detected in procedure S102 is equal to or higher than an adverse environment threshold Pa for snow and for a condition where another vehicle does not exist (procedure S104).

The condition score of snow is one of detection scores of the environment condition around the own vehicle 2. The condition score of snow is an amount representing a condition of snow in front of the own vehicle 2 as a numerical value. The condition score of snow becomes higher as an amount of snow in front of the own vehicle 2 becomes larger. The adverse environment threshold Pa for snow and for a condition where another vehicle does not exist is an adverse environment threshold for snow when neither a passing vehicle nor an oncoming vehicle exists. The adverse environment threshold Pa for snow and for a condition where another vehicle does not exist is, for example, 30.

When it is determined that the condition score of snow is equal to or higher than the adverse environment threshold Pa for snow and for a condition where another vehicle does not exist, the ECU 10 determines that the surrounding environment of the own vehicle 2 is an adverse environment (procedure S105). Then, the ECU 10 controls the high beam light source 5 to turn OFF high beam (procedure S106) and executes procedure S101 described above again.

When it is determined in procedure S104 that the condition score of snow is not equal to or higher than the adverse environment threshold Pa for snow and for a condition where another vehicle does not exist, the ECU 10 determines whether the condition score of rain detected in procedure S102 is equal to or higher than an adverse environment threshold Pb for rain and for a condition where another vehicle does not exist (procedure S107).

The condition score of rain is another one of the detection scores of the environment condition around the own vehicle 2. The condition score of rain is an amount representing a condition of rain in front of the own vehicle 2 as a numerical value. The condition score of rain becomes higher as an amount of rain in front of the own vehicle 2 becomes larger. The adverse environment threshold Pb for rain and for a condition where another vehicle does not exist is an adverse environment threshold for rain when neither a passing vehicle nor an oncoming vehicle exists. The adverse environment threshold Pb for rain and for a condition where another vehicle does not exist is, for example, 40.

Low visibility in front of the own vehicle 2 is more likely to occur in snow weather than in rain weather. Thus, the adverse environment threshold Pa for snow and for a condition where another vehicle does not exist is smaller than the adverse environment threshold Pb for rain and for a condition where another vehicle does not exist such that the surrounding environment is more likely to be determined as an adverse environment in a snow scene than a rain scene.

When it is determined that the condition score of rain is equal to or higher than the adverse environment threshold Pb for rain and for a condition where another vehicle does not exist, the ECU 10 determines that the surrounding environment of the own vehicle 2 is an adverse environment (procedure S105). Then, the ECU 10 controls the high beam light source 5 to turn OFF high beam (procedure S106) and executes procedure S101 described above again.

When it is determined that the condition score of rain is not equal to or higher than the adverse environment threshold Pb for rain and for a condition where another vehicle does not exist, the ECU 10 determines that the surrounding environment of the own vehicle 2 is not an adverse environment (procedure S108). Then, the ECU 10 controls the high beam light source 5 to turn ON high beam (procedure S109) and executes procedure S101 described above again.

When it is determined that a passing vehicle or an oncoming vehicle has been detected in procedure S103, the ECU 10 determines whether the passing vehicle or the oncoming vehicle exists within a specified distance from the own vehicle 2 (procedure S110). The specified distance is, for example, 30 m. When it is determined that neither the passing vehicle nor the oncoming vehicle exists within the specified distance from the own vehicle 2, the ECU 10 executes processing in procedure S104 described above and subsequent processing.

When it is determined that the passing vehicle or the oncoming vehicle exists within the specified distance from the own vehicle 2, the ECU 10 determines whether the passing vehicle or the oncoming vehicle exists within one lane on the right side or the left side of the own vehicle 2 (procedure S111). When it is determined that neither the passing vehicle nor the oncoming vehicle exists within one lane on the right side or the left side of the own vehicle 2, the ECU 10 executes the processing in procedure S104 described above and subsequent processing.

When it is determined that the passing vehicle or the oncoming vehicle exists within one lane on the right side or the left side of the own vehicle 2, the ECU 10 determines whether the condition score of snow detected in procedure S102 is equal to or higher than an adverse environment threshold Qa for snow and for a condition where another vehicle exists (procedure S112). The adverse environment threshold Qa for snow and for a condition where another vehicle exists is an adverse environment threshold for snow when a passing vehicle or an oncoming vehicle exists. The adverse environment threshold Qa for snow and for a condition where another vehicle exists is, for example, 10.

When a passing vehicle or an oncoming vehicle is close to the own vehicle 2, snow is splashed by the passing vehicle or the oncoming vehicle, and thus, low visibility in front of the own vehicle 2 is likely to occur. Thus, the adverse environment threshold Qa for snow and for a condition where another vehicle exists is smaller than the adverse environment threshold Pa for snow and for a condition where another vehicle does not exist such that the surrounding environment is more likely to be determined as an adverse environment when the passing vehicle or the oncoming vehicle exists within one lane on the right side or the left side of the own vehicle 2.

When the condition score of snow is equal to or higher than the adverse environment threshold Qa for snow and for a condition where another vehicle exists, the ECU 10 determines that the surrounding environment of the own vehicle 2 is an adverse environment (procedure S105). Then, the ECU 10 controls the high beam light source 5 to turn OFF high beam (procedure S106) and executes procedure S101 described above again.

When it is determined in procedure S112 that the condition score of snow is not equal to or higher than the adverse environment threshold Qa for snow and for a condition where another vehicle exists, the ECU 10 determines whether the condition score of rain detected in procedure S102 is equal to or higher than an adverse environment threshold Qb for rain and for a condition where another vehicle exists (procedure S113). The adverse environment threshold Qb for rain and for a condition where another vehicle exists is an adverse environment threshold for rain when a passing vehicle or an oncoming vehicle exists. The adverse environment threshold Qb for rain and for a condition where another vehicle exists is 20.

When a passing vehicle or an oncoming vehicle is close to the own vehicle 2, spray of rain is splashed by the passing vehicle or the oncoming vehicle, and thus, low visibility in front of the own vehicle 2 is likely to occur. Thus, the adverse environment threshold Qb for rain and for a condition where another vehicle exists is smaller than the adverse environment threshold Pb for rain and for a condition where another vehicle does not exist so such that the surrounding environment is more likely to be determined as an adverse environment when the passing vehicle or the oncoming vehicle exists within one lane on the right side or the left side of the own vehicle 2.

Further, snow is lighter than rain. Thus, a period during which splashed snow floats in the air is longer than a period during which splashed rain floats in the air. It can be therefore considered that a period during which low visibility in front of the own vehicle 2 continues due to the splashed snow is longer than a period during which low visibility in front of the own vehicle 2 continues due to the splashed rain. Thus, the adverse environment threshold Qa for snow and for a condition where another vehicle exists is smaller than the adverse environment threshold Qb for rain and for a condition where another vehicle exists such that the surrounding condition is more likely to be determined as an adverse environment in a snow scene than in a rain scene.

When it is determined that the condition score of rain is equal to or higher than the adverse environment threshold Qb for rain and for a condition where another vehicle exists, the ECU 10 determines that the surrounding environment of the own vehicle 2 is an adverse environment (procedure S105). Then, the ECU 10 controls the high beam light source 5 to turn OFF high beam (procedure S106) and executes procedure S101 described above again.

When it is determined that the condition score of rain is not equal to or higher than the adverse environment threshold Qb for rain and for a condition where another vehicle exists, the ECU 10 determines that the surrounding environment of the own vehicle 2 is not an adverse environment (procedure S108). Then, the ECU 10 controls the high beam light source 5 to turn ON high beam (procedure S109) and executes procedure S101 described above again.

Here, the surrounding environment detection unit 11 executes procedure S102. The target detection unit 12 executes procedure S101. The other vehicle determination unit 13 executes procedures S103, S110, and S111. The adverse environment determination unit 14 executes procedures S104, S105, S107, S108, S112, and S113. The high beam control unit 17 of the lamp control unit 15 executes procedures S106 and S109.

In the vehicle headlight control device 1 as described above, when the own vehicle 2 is traveling on a snow road during night-time, and when an oncoming vehicle or a preceding vehicle is not traveling in front of the own vehicle 2, further, the circumference of the own vehicle 2 is dark, and the own vehicle 2 is traveling at a speed equal to or higher than a specified speed, the high beam of the head lamp 3 is in an ON state.

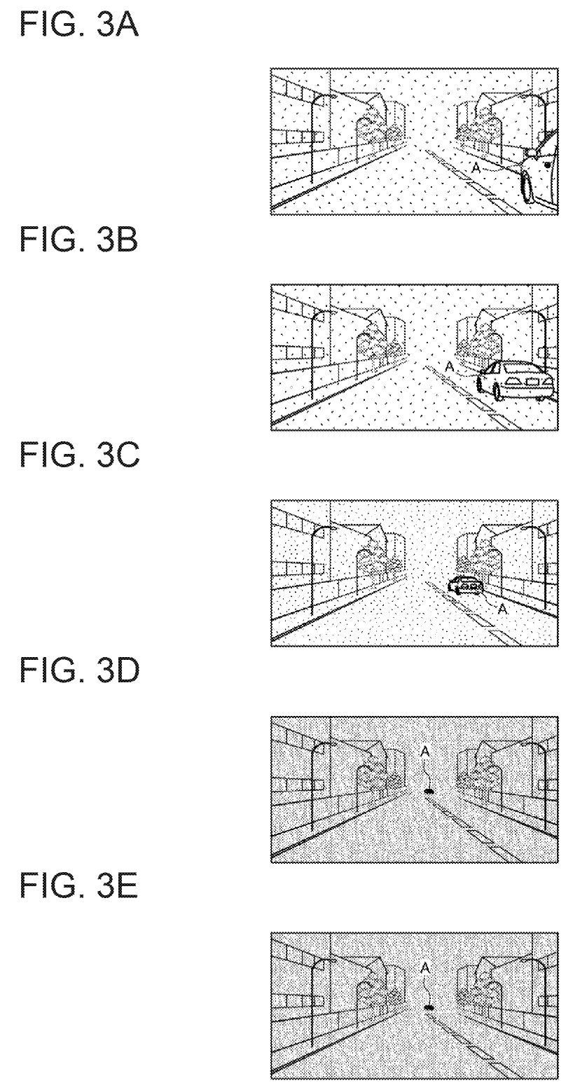

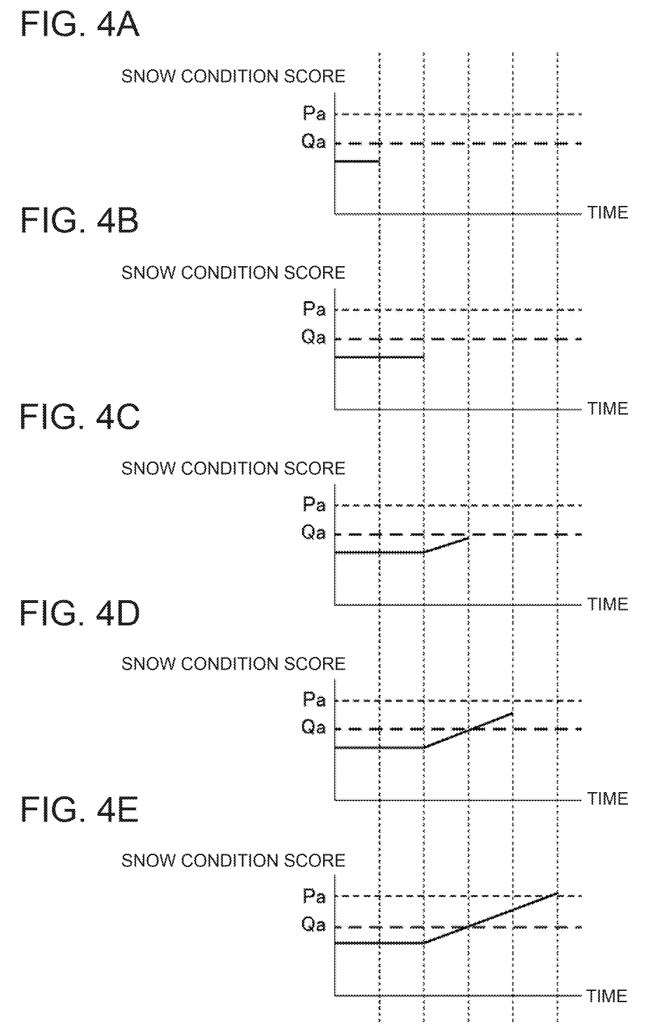

In such a state, as illustrated in FIG. 3A, when there is a passing vehicle A that tries to pass through the own vehicle 2 on a lane on the right side of a traveling lane on which the own vehicle 2 is traveling, by comparing the condition score of snow with the adverse environment threshold Qa for snow and for a condition where another vehicle exists, it is determined whether the surrounding environment of the own vehicle 2 is an adverse environment. In this event, as illustrated in FIG. 4A, in a state where the condition score of snow is lower than the adverse environment threshold Qa for snow and for a condition where another vehicle exists, it is determined that the surrounding environment of the own vehicle 2 is not an adverse environment. Further, the passing vehicle A has not traveled in front of the own vehicle 2 yet. Thus, high beam of the head lamp 3 remains in an ON state.

Thereafter, as illustrated in FIG. 3B, the own vehicle 2 is passed through by the passing vehicle A. In this event, as illustrated in FIG. 4B, when the condition score of snow does not change, the condition score of snow is lower than the adverse environment threshold Qa for snow and for a condition where another vehicle exists, and thus, it is determined that the surrounding environment of the own vehicle 2 is not an adverse environment. However, the passing vehicle A is traveling in front of the own vehicle 2. Thus, the state of the high beam of the head lamp 3 is switched from an ON state to an OFF state.

Thereafter, as illustrated in FIG. 3C, snow on the road is splashed as a result of the passing vehicle A passing through the own vehicle 2. Then, as illustrated in FIG. 4C, the condition score of snow becomes higher, but the condition score of snow is lower than the adverse environment threshold Qa for snow and for a condition where another vehicle exists, and thus, it is determined that the surrounding environment of the own vehicle 2 is not an adverse environment. Further, the passing vehicle A is traveling in front of the own vehicle 2, and thus, the high beam of the head lamp 3 remains in an OFF state.

Thereafter, as illustrated in FIG. 3D, visibility in front of the own vehicle 2 degrades due to the splashed snow. Then, as illustrated in FIG. 4D, the condition score of snow becomes further higher. Then, if the condition score of snow becomes higher than the adverse environment threshold Qa for snow and for a condition where another vehicle exists, it is determined that the surrounding environment of the own vehicle 2 is an adverse environment. Thus, the OFF state of the high beam of the head lamp 3 is maintained regardless of whether the passing vehicle A that is traveling in front of the own vehicle 2 exists.

Thereafter, as illustrated in FIG. 3E, the visibility in front of the own vehicle 2 further degrades due to the splashed snow and becomes a state where a street lamp and a traffic light in front of the own vehicle 2 can be barely viewed. Then, as illustrated in FIG. 4E, the condition score of snow becomes further higher. Also in this case, the condition score of snow is higher than the adverse environment threshold Qa for snow and for a condition where another vehicle exists, and thus, it is determined that the surrounding environment of the own vehicle 2 is an adverse environment, and the OFF state of the high beam of the head lamp 3 is maintained.

By the way, if a passing vehicle or an oncoming vehicle exists, recognition performance of the camera 7 becomes unstable due to splash of spray of rain or snow. Thus, there is a possibility that high beam may be radiated in front of the own vehicle 2 although an oncoming vehicle or a preceding vehicle is traveling in front of the own vehicle 2. It is therefore necessary to determine whether the surrounding environment of the own vehicle 2 is an adverse environment.

However, in snow weather, the following trouble occurs when it is determined whether the surrounding environment of the own vehicle 2 is an adverse environment by comparing the condition score of snow with the adverse environment threshold Pa for snow and for a condition where another vehicle does not exist.

In other words, even if visibility in front of the own vehicle 2 degrades due to splashed snow (see FIG. 3D), the condition score of snow is lower than the adverse environment threshold Pa for snow and for a condition where another vehicle does not exist, and thus, it is determined that the surrounding environment of the own vehicle 2 is not an adverse environment (see FIG. 4D). Further, visibility in front of the own vehicle 2 degrades due to splashed snow, and thus, although the passing vehicle A is traveling in front of the own vehicle 2, the camera 7 fails in detection of the passing vehicle A. As a result, the state of the high beam of the head lamp 3 is switched from the OFF state to the ON state.

Thereafter, if a street lamp and a traffic light in front of the own vehicle 2 can be barely viewed (see FIG. 3E), the condition score of snow becomes higher than the adverse environment threshold Pa for snow and for a condition where another vehicle does not exist, and thus, it is determined that the surrounding environment of the own vehicle 2 is an adverse environment (see FIG. 4E). Then, the state of the high beam of the head lamp 3 is switched from the ON state to the OFF state.

On the other hand, in the present embodiment, when the passing vehicle A exists, it is determined whether the surrounding environment of the own vehicle 2 is an adverse environment by comparing the condition score of snow with the adverse environment threshold Qa for snow and for a condition where another vehicle exists that is smaller than the adverse environment threshold Pa for snow and for a condition where another vehicle does not exist. Thus, if the visibility in front of the own vehicle 2 degrades due to snow splashed when the passing vehicle A passes through the own vehicle 2, the surrounding environment of the own vehicle 2 is likely to be determined as an adverse environment. Thus, even if the camera 7 fails in detection of the passing vehicle A due to low visibility in front of the own vehicle 2, the high beam of the head lamp 3 is in an OFF state.

As described above, according to the present embodiment, the environment condition around the own vehicle 2 is detected, and whether another vehicle (passing vehicle) that passes through the own vehicle 2 or another oncoming vehicle (oncoming vehicle) that goes by the own vehicle 2 exists is detected. Then, by comparing the detection score of the environment condition around the own vehicle 2 with the adverse environment threshold according to the environment condition around the own vehicle 2, whether the surrounding environment of the own vehicle 2 is an adverse environment is determined. By comparing the detection score of the environment condition with the adverse environment threshold according to the environment condition in this manner, whether the surrounding environment of the own vehicle 2 is an adverse environment is quickly determined. Here, the adverse environment threshold differs depending on whether a passing vehicle or an oncoming vehicle exists. Thus, the detection score of the environment condition is compared with the adverse environment threshold suitable for whether a passing vehicle or an oncoming vehicle exists, and thus, whether the surrounding environment of the own vehicle 2 is an adverse environment is determined with high accuracy. As described above, even when a passing vehicle or an oncoming vehicle exists, it is possible to determine whether the surrounding environment of the own vehicle 2 is an adverse environment with high accuracy and quickly. This results in making it possible to prevent high beam from being radiated in front of the own vehicle 2 although another vehicle is traveling in front of the own vehicle 2.

Further, in the present embodiment, a state of rain or snow is detected as the environment condition around the own vehicle 2, and the adverse environment threshold differs in accordance with whether a passing vehicle or an oncoming vehicle exists and the state of rain or snow. Thus, when a passing vehicle or an oncoming vehicle exists in rain or snow weather, whether the surrounding environment of the own vehicle 2 is an adverse environment is determined while it is predicted that the visibility in front of the own vehicle 2 becomes low due to splash of rain or snow. Thus, even in rain or snow weather, it is possible to determine whether the surrounding environment of the own vehicle 2 is an adverse environment with high accuracy.

Further, rain or snow is splashed when a passing vehicle passes through the own vehicle 2, and when an oncoming vehicle goes by the own vehicle 2, and thus, low visibility in front of the own vehicle 2 is likely to occur. Further, a period during which snow is splashed is longer than a period during which rain is splashed. Thus, a period during which low visibility in front of the own vehicle 2 continues is likely to be longer in snow weather than in rain weather. Thus, in the present embodiment, by making the adverse environment threshold when a passing vehicle or an oncoming vehicle exists smaller than the adverse environment threshold when neither a passing vehicle nor an oncoming vehicle exists and making the adverse environment threshold for a state of snow smaller than the adverse environment threshold for a state of rain, it is possible to determine whether the surrounding environment of the own vehicle 2 is an adverse environment in rain or snow weather with further high accuracy.

Further, in the present embodiment, the adverse environment threshold is changed depending on the environment condition around the own vehicle 2 when it is detected that a passing vehicle or an oncoming vehicle exists within a specified distance from the own vehicle 2, so that the adverse environment threshold is not changed in a state where the passing vehicle or the oncoming vehicle is separated from the own vehicle 2 by a distance longer than the specified distance. Thus, in a state where low visibility in front of the own vehicle 2 is less likely to occur because a passing vehicle or an oncoming vehicle is separated from the own vehicle 2 in rain or snow weather, the surrounding environment of the own vehicle 2 is less likely to be determined as an adverse environment. It is therefore possible to prevent radiation of the high beam in front of the own vehicle 2 from being uselessly stopped.

Further, in the present embodiment, the environment condition around the own vehicle 2 and whether a passing vehicle or an oncoming vehicle exists are detected using the camera 7 that captures an image of the circumference of the own vehicle 2. By using the camera 7 that captures an image of the circumference of the own vehicle 2 in this manner, it is possible to detect the environment condition around the own vehicle 2 and whether a passing vehicle or an oncoming vehicle exists through simple processing at low cost.

Note that the present disclosure is not limited to the above-described embodiment. For example, while in the above-described embodiment, a state of rain or snow is detected as the environment condition around the own vehicle 2, but a state of dense fog, and the like, may be detected in addition to the state of rain or snow.

Further, while in the above-described embodiment, whether a passing vehicle or an oncoming vehicle exists is detected using the camera 7 that captures an image of the circumference of the own vehicle 2, the form is not particularly limited, and, for example, whether a passing vehicle or an oncoming vehicle exists may be detected using a distance sensor such as, for example, a LiDAR.

Further, while in the above-described embodiment, a state of rain or snow, and the like, are detected using the camera 7 that captures an image of the circumference of the own vehicle 2, the form is not particularly limited, and the state of rain or snow, and the like, may be detected based on information regarding an operation state of a wiper in place of or in addition to the camera 7.

What is claimed is:

1. A surrounding environment determination device configured to determine a surrounding environment of an own vehicle upon control of high beam of the own vehicle, the surrounding environment determination device comprising:
a surrounding condition detection unit configured to detect an environment condition around the own vehicle;
an other vehicle detection unit configured to detect whether another vehicle that passes through the own vehicle or another oncoming vehicle that goes by the own vehicle exists; and
an adverse environment determination unit configured to determine whether the surrounding environment of the own vehicle is an adverse environment based on the environment condition around the own vehicle detected by the surrounding condition detection unit and whether the other vehicle exists detected by the other vehicle detection unit, wherein:
the adverse environment determination unit is configured to:
perform a comparison a detection score of the environment condition around the own vehicle with an adverse environment threshold according to the environment condition around the own vehicle; and
determine whether the surrounding environment of the own vehicle is an adverse environment based on a result of the comparison; and
the adverse environment threshold differs depending on whether the other vehicle exists.

2. The surrounding environment determination device according to claim 1, wherein:
the surrounding condition detection unit is configured to detect a state of rain or snow as the environment condition; and
the adverse environment threshold differs depending on whether the other vehicle exists and the state of rain or snow.

3. The surrounding environment determination device according to claim 2, wherein:
the adverse environment threshold when the other vehicle exists is smaller than the adverse environment threshold when the other vehicle does not exist; and
the adverse environment threshold for the state of snow is smaller than the adverse environment threshold for the state of rain.

4. The surrounding environment determination device according to claim 1, wherein:
the other vehicle detection unit is configured to detect whether the other vehicle exists within a specified distance from the own vehicle; and
the adverse environment determination unit is configured to change the adverse environment threshold depending on the environment condition around the own vehicle when the other vehicle detection unit detects that the other vehicle exists within the specified distance from the own vehicle.

5. The surrounding environment determination device according to claim 1, wherein:
the surrounding condition detection unit is configured to detect the environment condition around the own vehicle using a camera that is configured to capture an image of a circumference of the own vehicle; and
the other vehicle detection unit is configured to detect whether the other vehicle exists using the camera.
